(19) United States
(12) Patent Application Publication
(10) Pub. No.: US 2018/0268175 A1
(43) Pub. Date: Sep. 20, 2018

(54) METHOD AND ARRANGEMENT FOR PROVIDING AND MANAGING INFORMATION LINKED TO RFID DATA STORAGE MEDIA IN A NETWORK

(71) Applicant: SMARTRAC INVESTMENT B.V., Amsterdam (NL)

(72) Inventor: Manfred Rietzler, Marktoberdorf (DE)

(21) Appl. No.: 15/985,680

(22) Filed: May 21, 2018

Related U.S. Application Data
(63) Continuation-in-part of application No. 15/405,360, filed on Jan. 13, 2017, now Pat. No. 9,977,932.
Application No. 15/405,360 is a continuation of application No. 14/122,894, filed on Nov. 27, 2013, now Pat. No. 9,582,690.

(30) Foreign Application Priority Data
May 31, 2011 (DE) 10 2011 103 740.7

(51) Int. Cl. G06K 7/10; G06Q 10/08; G06Q 50/28

(52) U.S. Cl. CPC G06K 7/10009; G06Q 50/28; G06Q 10/08

(57) ABSTRACT

A method provides and manages information linked to RFID data storage media in a network with data transmission between an RFID data storage medium and an RFID reading unit, integrated in a mobile radio device, for reading the data stored on the RFID data storage medium. A data link is set up to a network server in a network via a radio interface of the mobile radio device. A data memory area on the network server is associated with the RFID data storage medium.

### CROSS REFERENCE TO RELATED APPLICATIONS

This application is a continuation-in-part of application Ser. No. 15/405,360, titled ‘METHOD AND ARRANGEMENT FOR PROVIDING AND MANAGING INFORMATION LINKED TO RFID DATA STORAGE MEDIA IN A NETWORK’ filed on Jan. 13, 2017, now U.S. Pat. No. 9,977,932, which is a continuation of and claims priority from U.S. patent application Ser. No. 14/122,894 titled ‘METHOD AND ARRANGEMENT FOR PROVIDING AND MANAGING INFORMATION LINKED TO RFID DATA STORAGE MEDIA IN A NETWORK’ filed on Nov. 27, 2013, now U.S. Pat. No. 9,582,690; which is a United States National Phase Application of International Application PCT/EP2012/001765 filed Apr. 25, 2012 and claims the benefit of priority under 35 U.S.C. §119 of German Patent Application DE 10 2011 103 740.7 filed May 31, 2011, the entire contents of which are incorporated herein by reference.

### BACKGROUND OF THE INVENTION

Transmission systems, which provide a wireless transmission path between two devices that are brought close together (short-range communication) and which enable data transfer with a global network via a mobile radio connection, have already become standard to a large extent. In the field of short-range communication, the data interface that is specified according to a procedure called NFC (Near Field Communication) is the most important one to be mentioned here (ISO/IEC 18092, ISO/IEC 21481). The technical basis of the NFC transmission system is constituted by an NFC data storage medium (NFC tag), which consists of a microchip with a data memory carrying information and of a coupling element and which, when advancing an NFC reading device, starts to interact with the electromagnetic field emitted by the same in such a way that the information stored on the NFC tag can be read out and processed. In this system configuration, the NFC tag is configured as a purely passive assembly, which obtains its energy from the alternating electromagnetic field of the reading device that initiates the transmission. Here, the connection setup and the data transmission proceed without any further manual configuration of the communicating devices.

This property makes the NFC technology interesting for contactless card systems, for instance in connection with contactless smartcards for access control or electronic payment systems.

For users of this technology, the automatic activation of the data transmission proves to be particularly convenient since no other actions beyond advancing the NFC tag are required.

New application fields arise due to the fact that the NFC functionality is integrated into mobile radio devices, in order to enable users, simply by advancing an NFC-enabled cell phone towards a passive NFC data storage medium, to make use of services that are provided by a global network to which the cell phone is connected via its radio interface. Combining the NFC technology with processes of mobile radio transmissions extends the range of capabilities of contactless card systems by making it possible that the data provided by an NFC tag can now be used via the mobile radio network in a comprehensive global network. With respect to future generations of mobile radio devices, it can thus be expected that many cell phones will be equipped with an NFC data interface. Therefore, the mobile radio device of the future will be capable both of emulating a passive NFC tag that is configured as a contactless smartcard (NFC Card Emulation Mode), and of reading and writing on an NFC tag (NFC Reader/Writer Mode) as well as of exchanging information with peer devices (NFC Peer-to-Peer Mode).

The applications are primarily directed towards consumers, i.e. individuals, for whom their cell phones represent a permanent means of communication and for whom it is made possible, by combining NFC technology and mobile communications, to make use of a broader range of NFC services with an “all-in-one” device.

Furthermore, the NFC interface is also specified such that it is compatible with the RFID—(Radio Frequency Identification) transmission standards ISO 14443 and ISO 15693. Thus, an NFC-enabled device for reading RFID data storage media (RFID tags, RFID transponders) can be used. Usually, RFID tags are connected to an object in a permanent manner, such that the same can be clearly identified by reading out the data that it possesses and that are stored in the RFID tag. Such a labeling accompanying the goods increasingly replaces attaching and scanning barcodes for identifying goods in the fields of goods transportation and goods logistics. In addition, RFID tags are also utilized in production operations for tracking components, for instance in car body manufacturing operations in the automotive industry. Up to now, only companies use RFID data storage media, such that individuals as consumers have virtually no chance to obtain further information “online” on the object that is provided with an RFID data storage medium.

### SUMMARY OF THE INVENTION

In some embodiments, the present invention is based on an object to provide, based on the data stored on an RFID data storage medium, additional object information for consumers and to make it possible for persons in possession of the RFID data storage medium to update said further information at any time.

In some embodiments, a method provides and manages information linked to RFID data storage media in a network. The method includes providing a data transmission between an RFID data storage medium and an RFID reading unit, integrated in a mobile radio device, for reading the data stored on the RFID data storage medium. A data link is setup to a network server in a network via a radio interface of the mobile radio device. A data memory area on the network server is associated with the RFID data storage medium.

In some embodiments, a fundamental idea of the present invention is based on incorporating RFID data storage media into a higher-level network. In this network, which, as explained further below, can advantageously be the Internet, on a network server a data memory area, on which additional object information on the object that is connected to the RFID data storage medium is stored, is associated with the RFID data storage medium.

For the consumer to be able to access said information, i.e. to be able to retrieve the object-related information from the network server, the RFID data storage medium can be clearly identifiable within the global network and, from the data that are stored on the RFID data storage medium, access data for the server data memory area can be generated and transferred into the comprehensive network, said access data subsequently allowing to retrieve the additional object information.

In some embodiments, identifying and reading the data that are stored on the RFID data storage medium is effected in a contactless way by means of data transmission between an RFID data storage medium and an RFID reading unit that is integrated in the mobile radio device. Due to the fact that the mobile radio device includes an integrated RFID interface, and that it has become normal to carry along a mobile radio device, it can be assumed that consumers, in a simple manner, will be able to identify a labeled RFID data storage medium and the object linked thereto, respectively, as well as to read out the stored data by advancing their cell phones to the data storage medium or by touching the data storage medium briefly. Via the radio interface of the mobile radio device, on the basis of the information that has been read out and processed as access data, the setup of a data link to the network server in the (global) network is subsequently effected, e.g., the data link between the mobile radio device and the network server is established.

By linking short-range communication (RFID technology) and mobile radio transmission, whereupon the method is based, as a network access in connection with a server data memory area that is associated with the RFID data storage medium, it is thus possible to provide additional object information to consumers. In addition, the method offers persons in possession of the RFID data storage medium the opportunity to update said additional information at any time. The method can also be extended to other tag devices, such as barcodes, such as UPC code, EAN code, Code 39, Code 128, ITF (interleave 2 of 5), Code 93, Codabar, GS1 Databar, and MSI Plessey, or two-dimensional barcodes (2d barcodes), such as QR code, Datamatrix code, PDF417, and Aztec. The method can also be extended to other reader devices, such as mobile or non mobile reader, and any network connectable reader.

In some embodiments, the association of the server data memory area with the RFID data storage medium is effected by addressing the server data memory area by means of an RFID data record that is stored on the RFID data storage medium. For example, access to the server data memory area that can be addressed via the (Internet) network can be established by a reader receiving its address from the data that are stored on the RFID data storage medium.

The association of the RFID data storage medium with the RFID data record for addressing the server data memory area can be effected by means of a serial number of the RFID data storage medium or by means of an identifier that is stored on the RFID data storage medium. It is also possible that the association of the RFID data storage medium with the RFID data record for addressing the server data memory area is effected by means of a combination of a serial number of the RFID data storage medium and of an identifier that is stored on the RFID data storage medium.

In order to prevent that the data stored on the RFID data storage medium can be misused by unauthorized persons, the data contained in the RFID data record for addressing the server data memory area can be stored in an encrypted way.

In some embodiments, the data transmission between the RFID data storage medium and the RFID reading unit is effected by means of an NFC interface, which is integrated into the mobile radio device and which is compatible with an RFID interface. As part of introducing NFC-enabled mobile radio devices in connection with the RFID compatibility of the NFC interface, it can be expected for the future that every person in possession of a cell phone that is NFC-enabled will also carry along an RFID reading device at the same time. As a result, an infrastructure is available which also makes it possible for consumers to retrieve additional object information “online” by means of a data link to a network server in a network via the radio interface of their mobile radio devices. Other RFID interfaces can be used, such as long range RFID tags using UHF (ultra high frequency), or RFID interface for passive or active RFID tags.

In some embodiments, the data transmission between the RFID data storage medium and the RFID reading unit as well as the setup of the data link to the network server via the radio interface is controlled by means of an application software that is installed on the mobile radio device. In the form of a small application program (“applet”) to be executed on the mobile radio device, said software can be made available to consumers and to persons in possession of the RFID data storage medium along with providing the server data memory area.

In some embodiments, after starting the application software, the RFID reading unit reads out the RFID data record from the RFID data storage medium, generates an access right for the server data memory area from these data, directs a request to the network server and processes the data received from the network server such that they can be presented on the mobile radio device. The starting command of the user thus causes the application software to perform the entire process of the data transmission and to accompany the corresponding actions in an interactive manner.

In some embodiments, the setup of the data link to the network server is effected within a global network, such as the Internet. Although a data link to a network server could also be set up in a local or private network, incorporating the RFID data storage medium into the Internet offers consumers much greater opportunities for obtaining information due to it being a worldwide network. Conversely, the additional object information that is stored on the data memory area of an Internet server reaches a very large target group.

In some embodiments, in order to make it possible to access the server data memory area from any location, the setup of the data link to the network server is effected via the radio interface that is specified in accordance with a mobile radio standard. Due to the high network coverage of the mobile radio networks, the same are suitable as access networks to the comprehensive global network. Via a radio interface that is specified according to a mobile radio standard, consumers gain access to the additional object information from almost everywhere that means from all those places where an object with an RFID data storage medium is located.

In some embodiments, the setup of the data link to the network server is effected via the radio interface that is specified in accordance with a local radio network standard. If no mobile radio network is available, access to a higher-level global network can be established, for instance, via a WLAN connection.

In some embodiments, the server data memory area is provided with an access authorization for different user categories with specific access rights. As a result, it becomes possible to set the access authorization and the type of access depending on the user.

For example, members of a first user category can possess the full access authorization including the write and read authorization and directly have access to the server data memory area, for example, by means of a password. Persons in possession of the RFID data storage medium could belong to said first user category, for whom it is thus possible to create and modify the data that are stored in the server data memory area themselves. As a security measure against use by unauthorized persons, protection by means of a password can be used.

Members of a second user category could possess the read authorization and, in the case of the Internet network, could indirectly have access to the server data memory area via an Internet portal. For example, for this user category, the indirect access to the database is effected by means of an access key which is generated when reading the RFID data storage medium. Furthermore, several other user categories can be established in order to make access to specific object information available only to a selected user group.

The server data memory area can also comprise data which present a link to other databases or websites. In this way, it is possible for users to have access to still further Internet-based information which relates to the object provided with the RFID data storage medium.

In some embodiments, on the RFID data storage medium further reference data for the server data memory area can be stored, which reference data are read out manually in an off-line mode and can either be used directly or serve for the manual setup of a network link. If the data link to the network server fails, the method can thus work with a limited scope of function.

The application software can also be a basic reading software, with which further reference data that are stored on the RFID data storage medium can be read out in order to be able to directly download extended application software modules onto the mobile radio device from the network. Thus, alternatively to providing an entire application software, it is possible to offer a software environment in which users compile the desired application software modules themselves. With the basic reading software, the reference data are read from the RFID data storage medium and, corresponding to the references contained in the reference data, the desired application software modules can be downloaded onto the mobile radio device and can be executed correspondingly.

In order to guarantee security and to prevent misuse of the data, the data transmission between the mobile radio device and the network server can be effected in an encrypted manner, wherein a key for an encryption algorithm is stored on the RFID data storage medium.

In some embodiments, by means of an additional signal input for determining an external condition, the RFID data record for addressing the server data memory area can be stored in a pre-set memory area in a targeted manner, corresponding to the state of the signal input. Depending on the state of the additional signal input, it can thus be set in which memory area on the RFID data storage medium the RFID data record is to be stored, wherein said memory area can be a subordinate area or a parallel area of the memory area on the RFID data storage medium.

In some embodiments, an arrangement is disclosed in which a network server has a data memory area which is associated with a RFID data storage medium.

The arrangement can comprise an RFID data storage medium, a mobile radio device with an integrated RFID reading unit for reading RFID data records and a network with a network server. Said arrangement can enables incorporating RFID data storage media into a higher-level network, such that it is possible for users of a mobile radio device that is equipped with an RFID reading device to retrieve additional object information that is linked to the RFID data storage medium from a server that is located within the network. For this purpose, the network server has, according to some embodiments of the invention, a data memory area which is associated with the RFID data storage medium.

In order to make it possible to access the server data memory area, the RFID data storage medium can have a memory area for receiving an RFID data record, which creates the association of the server data memory area with the RFID data storage medium by addressing the server data memory area. This means that the server data memory area can be addressed via the RFID data record which is stored on the RFID data storage medium.

In some embodiments, the mobile radio device comprises an RFID interface, such as an NFC interface, which is compatible with the RFID device for reading the RFID device. Due to the increasing number of NFC-enabled mobile radio devices which are capable of emulating an RFID interface, it is made possible for users of cell phones to access further information that is stored outside of the RFID data storage medium via the (mobile) radio network.

In some embodiments, the network can be a global network, such as the Internet. By incorporating the RFID data storage medium into the Internet, the object-related additional information that is linked to the RFID data storage medium is available from almost every location at which an RFID data storage medium is present.

In some embodiments, the RFID data storage medium has a memory area for receiving further access data and reference data. In this way, besides the RFID data record for addressing the server data memory area, further data can be stored directly on the RFID data storage medium, which, in the case of a transmission fault on the radio path into the (global) network, serve to make possible limited working in an off-line mode.

In some embodiments, the RFID data storage medium can have an additional signal input for determining an external condition with which the RFID data record for addressing the server data memory area can be stored in a pre-set memory area in a targeted manner, corresponding to the state of the signal input. Said signal input can be a sensor or a switch, which, by its state, sets in which memory area the association data are stored in the RFID data storage medium.

Other advantageous design features of the method and of the arrangement result from the following description and from the drawings, which illustrate embodiments of the invention in an exemplary manner. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a schematic illustration of an arrangement according to some embodiments; and

FIG. 2 is a schematic illustration according to FIG. 1 with a message sequence.

### DESCRIPTION OF THE PREFERRED EMBODIMENTS

In some embodiments, the invention relates to systems and methods for providing and managing information linked to data storage media in a network. The methods can include data transmission between a data storage medium and a reading unit, integrated in a network connectable device, for reading the data stored on the data storage medium, and also setup of a data link to a network server in a network via an interface of the network connectable device.

In some embodiments, the invention also relates to arrangements for providing and managing information linked to data storage media, such as RFID data storage media, in a network. The arrangements can include a data storage medium, a network connectable device such as a mobile radio device with an integrated reading unit for reading data records of the storage medium, and a network with a network server.

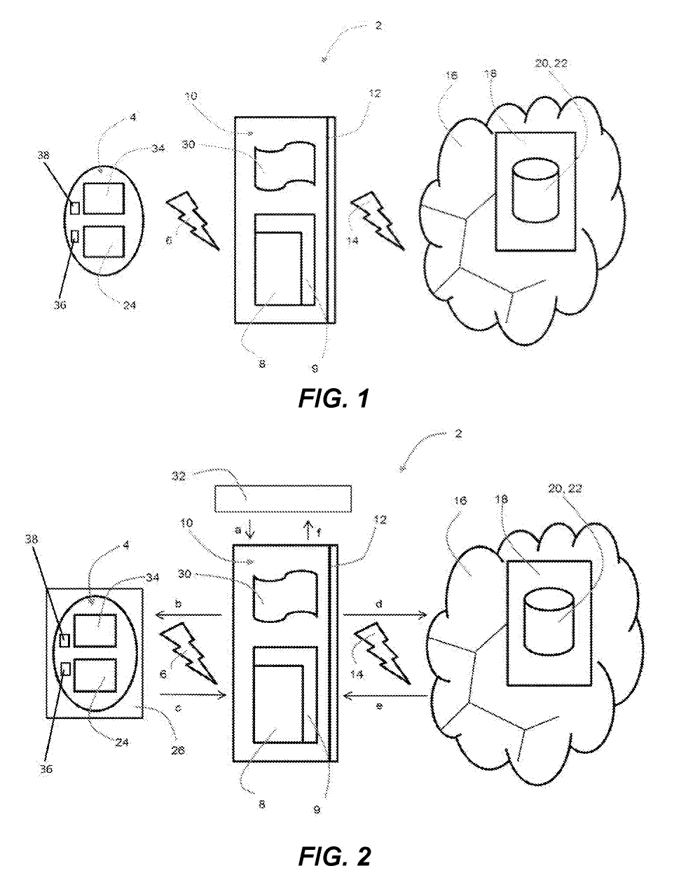

FIG. 1 illustrates a configuration for managing an RFID tag using a mobile radio device according to some embodiments. An RFID data storage medium 4 is illustrated, which is coupled to an RFID reading unit 8 via a contactless (Near Field) data transmission 6. The RFID data storage medium includes a serial number 36 and an additional signal input 38, such as a sensor. The RFID reading unit 8 is integrated into a mobile radio device 10 which sets up a data link 14 to the network 16 (Internet) via its radio interface 12. The RFID reading unit 8 includes an NFC interface 9. Within the network 16, a network server 18 is installed, which, configured as a database server, stores additional object information 22, which is linked to the RFID data storage medium 4, in a server data memory area 20. The linking is effected by addressing the server data memory area 20 by means of an RFID data record 24 which is stored on the RFID data storage medium 4.

In FIG. 2, the schematic illustration according to FIG. 1 can be seen, supplemented by a message sequence a to f, with which the additional object information 22 on an object 26 is provided. The additional information 22 can, for instance, consist of details regarding the production data or the expiry date of a product, regarding the production site or can consist of other product-related data or can comprise general producer details. Thus, the method can also be used as an authenticity labeling of goods, in that the consumer 32 installs an application software 30 on his mobile radio device 10, which assumes control of the message sequence a to f, as explained in the following.

After the application software 30 has been started, step a, by the user 32, initially, a request b is directed to the RFID data storage medium 4. If the review of the RFID data storage medium 4 has a positive result, the same responds with the release c of the data that are stored on the RFID data record 24. After the data have been read out c, the application software 30 generates an access right for the server data memory area 20 from these data and directs a request d to the network server 18, in order to retrieve e the additional object information 22. Subsequently, the information 22 that is received is correspondingly analyzed, processed and presented to the user 32 by the application software 30.

Alternatively to installing an entire application software 30, it is also conceivable that the user 32 initially only installs a software environment or a basic software, in which he subsequently inserts specific software modules 30 compiled by himself, for instance for the purpose of authenticity labeling, by downloading the same from the network server 18. For this purpose, the link to the corresponding downloads could be indicated by reference data on the RFID data storage medium 4. For receiving said reference data, the RFID data storage medium 4 can have a further memory area 34.

In some embodiments, the present invention discloses systems and methods, and data storage elements employed in the systems and methods, to extend the information stored in the data storage elements. The methods can include storing a link to a network location in a data storage element. When a network connected reader accesses the data storage element, the link can allow the reader to obtain information stored in the network location. Advantages of the information extending methods can include a simplification of the storage requirements of the data storage elements, since the reader can display a lot more information than what is stored in the data storage elements. For example, a limited memory can be used to store an internet address in the data storage element, but the reading information can be limited only by the storage space allocated to the network location at the stored internet address.

Further, the methods can allow updates of information stored in the data storage elements without physically accessing the data storage elements, for example, by updating information stored in the network location. For example, a business card can contain a link to a network location, which stores the contact information of the person whose name appears on the business card. When a reader accesses the business card, the reader can retrieve the most updated contact information of the person.

In some embodiments, the data storage elements can include a data component, e.g., a component of the data storage elements that can be used to store information or data. The data storage elements can include an access component, e.g., a component of the data storage elements that can allow a reader to access the data component, e.g., to allow the reader to obtain the information or data stored in the data component. The access component can be integrated or built into the data component, forming a data component can allow reader access.

In some embodiments, the data storage elements can include labels or tags, e.g., labels which can be attached to someone or something to provide identification or other information. For example, the data storage elements can include barcodes, such as one-dimensional barcodes or two-dimensional barcodes. The data components can include the information conveyed in the configuration of the barcodes. The access components can include the visible element of the barcodes, which can allow a reader having a light source, such as a laser, to access the data components to decode the information encoded in the barcodes.

The data storage elements can include RFID devices, such as passive, battery-assisted passive, or active RFID devices, low frequency (about 30 kHz-300 kHz, such as 125-134 kHz) RFID devices, high frequency (about 3 MHz to 30 MHz, such as 13.56 MHz) RFID devices, and ultra-high frequency (about 300 MHz-3 GHz, such as 856-960 MHz) RFID devices. The data components of the RFID devices can include a storage element, such as a memory portion of the RFID devices. The access components can include a transmitter/receiver module, together with an antenna to allow the RFID to communicate with a reader through the frequency of the RFID devices.

The present specification discusses in details about NFC devices, which is a subset of high frequency RFID devices operated at 13.57 MHz, with the standards and protocols based on RFID standards outlined in ISO/IEC 14443, FeliCa, and the basis for parts of ISO/IEC 18092, which deal with the use of RFID in proximity cards. However, the invention can be equally applied to other types of RFID devices, and to other types of data storage elements, including barcodes.

In some embodiments, the readers can include devices that are configured to be able to access the access component of the data storage elements. The access configuration can be specific to the types of data storage elements. For example, a scanner having a light source can be used to access barcodes. An RFID reader having an RF transmitter/receiver module can be used to access RFID devices having corresponded operation frequency. For example, a NFC RFID reader can be used to access RFID devices following NFC standards.

The readers can also be configured to be network connectable, e.g., the readers can be linked to a network to access information from the network. The readers can be mobile or can be stationary. The readers can be connected to the network through wire connection or through wireless connection. The present specification discusses in details about mobile radio devices, such as cell phones. However, the invention can be equally applied to other types of network connectable readers, such as RFID readers that can be connected to the internet, or point of sale terminals equipped with a reader and network connectable.

In some embodiments, the network can include wire or wireless local area networks, or wide area networks such as the internet, which is a global network that supports communications by using a common language.

In some embodiments, the methods can include reading a tag, such as an RFID device, by a reader, such as a mobile radio device equipped with an RFID reader. The reader can be configured to read data from the tag, and also the reader can be configured to parse the read data to obtain a link to a network location. In some embodiments, the tag can contain only the link, so that reader can simply read the data from the tag and use the read data as the link to the network location.

Upon having the link, the reader can connect to the network to access information at the network location pointed to by the link. The reader can then display the information. Thus, without knowing the access details, it can appear as though the display information is stored in the tag, e.g., it seems that the reader reads the tag and then displaying the information obtained from reading from the tag.

In some embodiments, the methods can be configured to have multiple classes of information access for accessing the data at the network location, e.g., there can be access codes to allow different entities to have different access, such as read access, write access, read and write access, and different read accesses for retrieving different information from the network location, e.g., from the location that the link in the data storage element directs to. For example, a business card can have an embedded tag, which contains a link to a network location which contains the contact information of the card person, e.g., the person whose name is on the business card. When the business card is read, the link is activated, and the network location returns the contact information to the reader. For access right, the card person can have write access to the data stored at the network location. The possession person, e.g., the person in possession of the business card or the person that the card person gives the business card to, can have read access, e.g., can retrieve the contact information of the card person.

A product can have an attached tag, which can provide information about the product when read. The tag can contain a link to a network location, which contains the product information. The manufacturer can have read and write access to the data at the network location, to prepare the information related to the product. A person trying to browse for the information related to the product can read the tag, and get product information related to the sale of the product, such as the price of the product, and the materials or ingredients of the product. A merchant can read the tag, and obtain information about the product inventory, and where are the nearest store locations. A person already purchased the product can read the tag, and get product information related to the care of the product, such as how to best maintain the product, and the warranty information for the product.

In some embodiments, the methods can be applied to digital payments, e.g., wire or wireless transfer of money between two devices through a network such as the internet. A tag, which can be a credit card, a debit card, a bank card, or any data storage device, can contain authentication data together with a link to processing center. Thus when perform payment, a reader can read the tag to know the location of the processing center. The reader then contact the processing center for authorizing payment, using authentication data from the tag. Thus, only the person in possession of the tag can authorize the payment, since the contact information of the processing center is embedded in the tag. This can also allow banks to issue their own cards, without going through the acquirer, e.g., a financial institution that process credit or debit card payments on behalf of a merchant.

In some embodiments, small merchants or individuals can use their readers, such as point of sale terminals or mobile radio devices, to access the cards for digital payments, using bank transfer or wire transfer of money from the buyer to the seller. A seller can read a bank card from a buyer, obtaining bank contact information, together with bank account information from the buyer. The reader then can contact the bank to transfer appropriate amount of money from the buyer to the seller. Authentication process can be used, such as the buyer to provide a pin number, or the buyer can sign a charge statement.

The issuer of the tag can have read and write access to the data at the network location, to provide the contact information to process the payment. A merchant can read the tag, and get the contact information, to contact the issuer for authorizing the payment.

In some embodiments, the classes of information access can be effected by using different readers, using different software such as different apps on a mobile radio device, or by entering a password. For example, a normal reader, e.g., a reader without any special access such as a user mobile radio device, can have a public read access to the tag. A point of sale terminal from a merchant, when reading a tag for digital payment, can have a merchant read access, for example, since the point of sale terminal can be previously authenticated for digital currency processing.

Password access can be used to provide different access classes. For example, a user can enter a password in the reader to change the access classes, such as a write password can allow the user to have write access, different read passwords can allow the user to access different information. The password entering process or location can be inconspicuous, for example, to increase a security of the information retrieval process.

Different software installed in the readers can provide different access classes. For example, a software can have a password built in, e.g., the write access software can automatically provide write access to the user. A software, or the reader, can have a portion of the link, and thus, when combining with the link read from the tag, can bring the reader to access a different network location for different information.

In some embodiments, the tags can have a portion of the link to the network location, or a link to a generic network location. The software or the reader can provide another portion of the link, for example, to provide a more specific or restricted network location. For example, the link from the tag can get a main page of a network site. The software or reader can provide a link portion, that, when combining with the tag link, can bring the reader to a specific page of the network site.

In some embodiments, the tag can have a link to a network location. The software or the reader can have another link that can modify or complement the tag link, to bring the reader to different network locations.

In some embodiments, the present invention discloses a method for obtaining data from a RFID tag containing a data link to a network server. The data link can include an address of the network server, such as the network address of the network server, or the internet address of an internet-connected server. The address can be the address of different memory areas of the network server, for example, to allow different RFID tags to access different sections of a same network server.

The method can include reading an RFID tag to obtain a data, including the link data. The link data in the RFID tag can be the data that can allow access to the network server. The network server is then accessed through the link data. Data from the network server can be shown on the reading unit that read the RFID tag. Other data from the RFID tag can be sent to the network server, for example, for authentication with the network server or for accessing different data from the network server. Accessing the network server can include generating an access right for the network server from the link data, and then directing a request to the network server for accessing data on the network server.

In some embodiments, in addition to the link information, other information can be included, such as additional information from the tag, information from the reader or the software. The information can be used for get proper data from the network location, such as for authentication purpose (e.g., password for reading accesses), or for complimenting the tag link to provide suitable information.

In some embodiments, the tag can contain the link to the network location, together with other information, such as authentication information. The authentication information can prevent persons possessing the link information, but not having the tag, from access the data at the network location. The other information can serve as a direct pointer, to guide the link to the proper network location. The other information can serve as a password, authenticating the reader to obtain data at the network location.

In some embodiments, the methods can include reading a tag, such as an RFID device, by a reader, such as a mobile radio device equipped with an RFID reader. The reader can be configured to read data from the tag, and also the reader can be configured to parse the read data to obtain a link to a network location. In some embodiments, the tag can contain the link and other information, so that reader can use the information as arguments to the link, to obtain appropriate data from the network location.

Upon having the link, the reader can connect to the network. The reader can use the information read together with the link to access appropriate information at the network location pointed to by the link. For example, the information can be used as authentication data for access confidential information.

In some embodiments, the reader, or the software running in the reader, can read the tag for the complete or partial link information. The reader or the software can add other information to the read data, e.g., to the link information which can be a complete link or a portion of the link. The information to be added to the information read from the tag can include data from the reader, such as location of the reader based on gps data, temperature of the environment, time of tag reading, or identifier of the reader, e.g., manufacturing information of the mobile radio device. The information can include data from the software, such as software version number, or other information incorporated within the software when the software is installed. The information can include data entering at the reader.

The additional information can serve as a guide to provide suitable network location to the reader, for example, based on the location of the reader, the environment temperature, or the read time. Different data can be provided to the reader based on the additional information. The additional information can also serve as authentication information, for example, by identifying the reader identification or the software version or identification.

In some embodiments, the methods can include reading a tag, such as an RFID device, by a reader, such as a mobile radio device equipped with an RFID reader. The reader can be configured to read data from the tag, and also the reader can be configured to parse the read data to obtain a link to a network location. The tag can contain the link, or the tag can contain the link and other information, so that reader can use the information as arguments to the link, to obtain appropriate data from the network location.

Upon having the link, the reader can connect to the network. The reader can provide other information to the network, such as the identifier of the reader. In some embodiments, the reader can be equipped with one or more sensors, such as a temperature sensor or a gps sensor, or information gathering or generating, such as a clock. The reader can then supply information reading from the sensors or from any devices from the reader to the network. In some embodiments, the reader can also supply additional information from the tag. The reader can also allow the user to enter information, such as a password. The information supplied from the reader, e.g., from a software running in the reader and reading information from the reader or from other devices in the reader, can be used to get different accesses from the network, such as read access, write access, read and write access, and different types of read or write access.

For example, a business card can be restricted to certain geographic locations, such as north America. Thus when a reader reading the business card is from outside the geographic area, such as in Asia, access to the information can be denied.

A product tag can use geographic locations to identify the type of persons accessing the tag. For example, at the manufacturer's site, as indicated by gps data from the reader, the reader can be from the manufacturing personnel, and information can be presented accordingly, such as providing write access. At store locations, the reader can be from potential customers or from the store personnel, and information related to the sale of the product can be presented. At other locations, such as at a residential area, the reader can be from persons already purchased the product, and information related to care and maintenance of the product can be shown.

In digital payment using tags such as credit card, debit card, or bank card, the locations and the time can be used as a security measure to provide authentication. For example, for merchant payments, the locations might need to be the store locations, and the time might need to be the business hours. Alternatively, a small business or individuals can register their readers, such as their point of sale terminal identifier or their mobile radio device identifier, so that when reading the tags for processing digital payments, the identifier of the readers can authenticate the process.

In addition, passwords obtained from the readers, such as a pin number, or a passcode can be used for authentication.

In some embodiments, the present invention discloses a method for digital payment using a RFID tag containing a data link to a network server. The method can include reading an RFID element to obtain a data, including the link data. The link data in the RFID tag can be the data that can allow access to the network server.

The network server is then accessed through the link data for posting or releasing a payment. The network server can send confirmation after a successful transaction.

In some embodiments, the present invention discloses dynamic tags for used in the information reading process. A dynamic tag can change its content, e.g., changing the data stored in the memory. For example, a dynamic tag can be coupled to a sensor, and data in the memory can be linked to the value of the sensor. Thus, when the sensor senses different situations, the tag can provide different data corresponded to the reading of the sensor.

In some embodiments, the dynamic tag can contain a changeable link to a network location, e.g., the link is coupled to the state of the sensor, thus the link can be changed based on the reading of the sensor.

In some embodiments, the dynamic tag can contain a link to a network location, together with additional changeable data, e.g., the data is coupled to the state of the sensor, thus the data can be changed based on the reading of the sensor. The link can be fixed, or can be changeable.

In some embodiments, the dynamic tag can include a sensor to indicate a condition, including a pass or fail sensor such as one-bit sensor of over-temperature, over-shock, over-dirtiness, over a humidity threshold. The dynamic tag can include a sensor to indicate a value, such as a temperature sensor providing a temperature, a humidity sensor providing a humidity level, a cleanliness sensor providing a level of cleanliness, such as a particulate measurement value, a fingerprint sensor, or a biometric sensor for biometric identification.

In some embodiments, the memory of the tag can be directly coupled to the sensor. Thus the tag can return to its original memory data when the sensor returns to its original sensed condition. For example, a moisture or dust sensor can be coupled to an RFID tag. When the sensor passes a threshold value, the data stored in the memory of the RFID tag changes accordingly. When the sensor returns to a value below the threshold sensor, the data of the RFID tag also returns to its original value. The sensor-coupled RFID tag can be used to monitor humidity or cleanliness conditions. For example, when a reader reads a dust-sensing RFID tag, the data returns from the RFID tag can provide an indication of the cleanliness level of the environment in which the dust-sensing RFID is located.

In some embodiments, the RFID tag can have a stored link to a network location. The link can be read by the reader, which can be used to contact the network location, which can provide information related to the RFID tag. For example, the data at the network location can show information about the environment of the RFID tag. In addition, the network location, when being accessed by the reader, can be configured to perform some responses. For example, when the reader reads a dirty RFID tag, e.g., a dust-sensing RFID tag with the dust sensor passing the dirty threshold level, the information about the condition of the RFID environment can be passed, by the reader, to the network location, for the network location to act upon the receipt of the RFID reading. For example, the network location can inform a maintenance team about the dirty condition, for the maintenance team to correct the situation.

When the reader reads a clean RFID tag, e.g., a dust-sensing RFID tag with the dust sensor reading below the dirty threshold level, the information about the condition of the RFID environment can be passed to the network location, for the network location to put out a notice about the cleanliness of the RFID environment.

In some embodiments, the tag can include a latch module, which can latch the content of the tag when the sensor reaches a value, such as a threshold. Thus, when the sensor changes value again, such as returning to its original value, the content of the tag, which has been latched, stays the same without returning to its original value.

For example, a moisture or dust sensor can be coupled to a latched RFID tag. The sensor-coupled latched RFID tag can be used to monitor humidity, cleanliness, or temperature conditions. For example, when a reader reads a temperature-sensing RFID tag, the data returns from the RFID tag can provide an indication of the thermal exposure of the product in which the temperature-sensing RFID is located. With the latch, even when the temperature is lowered, the high temperature is stilled registered in the RFID tag, meaning the memory of the RFID tag is latched to the highest temperature, and not becoming lower when the temperature sensor registers a lower temperature.

The RFID tag can be configured to provide information from the RFID tag to a network location, and can be configured to perform responses based on conditions of the RFID tag. For example, when the RFID tag is read by a reader, the tag can return a link to a network location for the reader to contact. Data at the network location can provide information related to the RFID tag, such as information about the environment of the RFID tag. In addition, the network location, when being accessed by the reader, can be configured to respond to the status or state of the sensor linked to the RFID tag. For example, when the reader reads a overtemp RFID tag, e.g., an RFID tag with an over temperature sensor for monitoring whether the product is exposed to too-high a temperature condition, the overtemp condition of the tag is noted by the network location, which can put an alert for the product indicating that the product has experienced temperature exceeding the temperature limit.

In some embodiments, the sensor can be used for authentication, especially biometric sensors. The owner of the RFID tag can activate the biometric sensor, validating the RFID tag. For example, a biometric-sensing RFID card (or other device formats) can have a biometric sensor programmed to the signature of the owner of the card, such as a fingerprint sensor recognizing the finger print of the card owner.

In some embodiments, to perform a digital or electronic payment, a person can hold the RFID card with the finger superimposed on the fingerprint sensor. The finger can activate the fingerprint sensor, which can change the data in the RFID card. For example, the link in the data of the RFID card can be changed to a valid link, e.g., a link to a valid network location. Other data in the RFID card can be changed, such as a validated status in the RFID card can be changed to a valid state when a proper finger print is read by the sensor. Thus, when a reader reads the RFID card, the biometric sensor of the fingerprint can validate the card. The reader then can access the link read from the RFID card, and contact the network location to initiate a digital payment. Other biometric sensor can be used instead of the finger print sensor.

In some embodiments, other inputs can be used for authentication, such as inputs from the reader, e.g., identifier of the reader, temperature, gps location, or time, or password, or input from software.

In some embodiments, the sensor data, the inputs from the tags, or the inputs from the readers or from the software can be used to obtain different accesses of information, such as read and write, write, read, and different levels of read accesses.

In some embodiments, the present invention discloses a method for digital payment using a sensor-coupled RFID tag. The RFID tag can include a sensor, such as a biometric sensor for authenticating the RFID tag. The method can include reading an RFID element to obtain a data. The data in the RFID tag can be configured to be changeable based on a status of a sensor coupled to the RFID tag. For example, the owner of the RFID tag can activate the sensor, such as by using a fingerprint pressing on a fingerprint sensor embedded in the RFID tag. The data read from the RFID tag thus is changed if the sensor is activated, e.g., authenticating the RFID tag. A network server is then contacted for posting or releasing a payment. The sensor data can be used for authentication of the RFID tag. Alternatively, the sensor data can be used for direct the network server to a different network location, for example, to denied or approved sections of the network server. The network server can send confirmation after a successful transaction.

In some embodiments, the RFID tag can include a credit card, a debit card, or a bank card. The RFID tag can be read by a pay terminal, e.g., a point of sale terminal responsible for posting or releasing payment based on instruction from the person carrying the RFID tag.

In some embodiments, the present invention discloses a method for digital payment using a sensor-coupled RFID tag. The RFID tag can include a sensor, such as a biometric sensor for authenticating the RFID tag. The RFID tag can include data to form a link to a network server. The method can include reading an RFID element to obtain a data, including a sensored data, a link data, or a sensored link data. The sensored data in the RFID tag can be the data that is configured to be changeable based on a status of the sensor coupled to the RFID tag. The link data in the RFID tag can be the data that can allow access to the network server. The sensored link data in the RFID tag can be the network link data that is configured to be changeable based on a status of the sensor coupled to the RFID tag.

The network server is then contacted for posting or releasing a payment. The sensor data can be used for authentication of the RFID tag. Alternatively, the sensor data can be used for direct the network server to a different network location, for example, to denied or approved sections of the network server. The network server can send confirmation after a successful transaction.

In some embodiments, the present invention discloses a method for monitoring and/or servicing using a sensor-coupled RFID tag. The RFID tag can include a sensor, such as a status or condition sensor of a product or an environment that the RFID tag is attached to. The RFID tag can include data to form a link to a network server. The method can include reading an RFID element to obtain a data, including a sensored data, a link data, or a sensored link data.

The network server is then contacted for the status of the sensor, e.g., the status or condition of the product or the environment. The network server then can notify responsible entity about non-normal status or condition of the sensor. The network server can also send out notice for servicing. Alternatively, the network server can send servicing personnel for servicing or maintenance of the product or environment in the case of abnormal status or condition of the sensor.

In some embodiments, the status or condition of the sensor can be transmitted to an entity responsible for monitoring the sensor. A service or maintenance can be notified based on the status or condition of the sensor

While specific embodiments of the invention have been shown and described in detail to illustrate the application of the principles of the invention, it will be understood that the invention may be embodied otherwise without departing from such principles.

What is claimed is:

1. A method comprising
reading, by a device, an RFID element to obtain a first data,
wherein the first data comprises information to form a data link to a network server,
wherein access to the network server is generated based on the information;
receiving, by the device, a second data from the network server.

2. The method as in claim 1,
wherein the device comprises an RFID reading unit to allow the device to access data stored in the RFID element.

3. The method as in claim 1,
wherein the first data comprises an address of a memory area of the network server.

4. The method as in claim 1 further comprising
sending, by the device, a third data to the network server for authentication with the network server or for accessing different data from the network server.

5. The method as in claim 1 further comprising
setting up the data link between the device and the network server, after reading the first data to generate the network server access.

6. The method as in claim 1 further comprising
setting up a data link between the device and the RFID element,
wherein the data link between the device and the RFID element is formed by means of an RFID reading system which is integrated into the device.

7. The method as in claim 1
wherein a software that is installed on the device is configured to control the formation of the data link for receiving the second data.

8. The method as in claim 1 further comprising
generating an access right for the network server from the first data,
directing a request to the network server for accessing the second data.

9. The method as in claim 1,
wherein the RFID element further comprises reference data for manually setting up the data link.

10. A method for digital payment, the method comprising
reading, by a device, an RFID element to obtain a first data,
wherein the first data comprises information to form a data link to a network server;
accessing, by the device, the network server based on the information for posting or payment release.

11. The method as in claim 10,
wherein the RFID element is embedded in a credit card, a debit card, or a bank card.

12. The method as in claim 10 further comprising
sending, by the device, a third data to the network server for authentication with the network server or for accessing different data from the network server.

13. The method as in claim 10,
wherein the RFID element is coupled to a biometric sensor,
wherein the biometric sensor is configured to authenticate the RFID element to the device or to the network server.

14. The method as in claim 10,
wherein the device is configured as a pay terminal for processing the RFID element for payment.

15. The method as in claim 10 further comprising
receiving, by a device, a confirmation regarding the post or payment release.

16. A method comprising
reading, by a device, an RFID element to obtain a first data,
wherein the first data is configured to be changeable based on a status of a sensor coupled to the RFID element,
wherein the first data comprises information to form a data link to a network server;
accessing the network server based on the information to transmit the status of the sensor.

17. The method as in claim 16,
wherein the status of the sensor is transmitted to an entity responsible for monitoring the sensor.

18. The method as in claim 16,
wherein the RFID element is configured to monitor conditions of a product or an environment.

19. The method as in claim 16,
wherein a maintenance service is notified based on the status of the sensor.

20. The method as in claim 16,
wherein the device is configured as a pay terminal for processing the RFID element for payment,
wherein the sensor comprises a biometric sensor,
wherein the status of the sensor is configured to authenticate the RFID element to the device or to the network server.
